(19) United States
(12) Patent Application Publication
(10) Pub. No.: US 2023/0406049 A1
(43) Pub. Date: Dec. 21, 2023

(54) DEVICE FOR INCREASING TIRE TRACTION

(71) Applicant: Laclede Chain Manufacturing Company, Vancouver, WA (US)

(72) Inventors: Steve HEUETT, Vancouver, WA (US); Bob GRUBE, Vancouver, WA (US); Tyler HEUETT, Vancouver, WA (US); Craig LANDON, La Center, WA (US)

(73) Assignee: Laclede Chain Manufacturing Company, Vancouver, WA (US)

(21) Appl. No.: 18/460,614

(22) Filed: Sep. 4, 2023

Related U.S. Application Data
(63) Continuation-in-part of application No. 17/123,376, filed on Dec. 16, 2020.
Application No. 17/123,376 is a continuation-in-part of application No. 15/948,897, filed on Apr. 9, 2018, now abandoned.

(51) Int. Cl. B60C 27/18; B60C 27/08

(52) U.S. Cl. CPC B60C 27/18; B60C 27/086

(57) ABSTRACT

Provided is a device for increasing traction, and, in particular, to a device to be fitted on a tire or wheel for increasing, enhancing, or improving, the traction, or friction, between the tire or wheel and a surface that the tire or wheel is in contact with. The device includes two or more line structures configured for encircling along two sidewalls of the tire, respectively. The device further includes a plurality of cross members configured for contacting a tread portion of the tire, the cross members connecting the line structures together. At least one cross member includes a strap with one or more traction components which include a plurality of raised structures arranged on a surface side of the traction components. Some raised structures are fitted with stud while others not. A strap suitable for use in the device is also provided.

### TECHNICAL FIELD

The present disclosure relates to a device for increasing traction. Particularly, the present disclosure relates to a device to be fitted on a tire or wheel for increasing the traction, or friction, between the tire or wheel and a surface that the tire or wheel is on.

### BACKGROUND

Chains, such as tire chains, are commonly used for vehicle tires or wheels to create or increase traction, or friction, between the tires/wheels and a surface, such as a road surface or a rail surface, that the tires/wheels is on or is moving on. Such chains need to be fitted, or mounted, onto tires/wheels, especially when roads or rails are covered with snow or ice. In many places of the world, it is mandatory by law for people to use traction devices such as tire chains when driving their vehicles in inclement weather involving snow or ice.

Tire chains are usually not intended for dry road/rail surfaces, because the tire chain components, or at least part of them, will rapidly wear when driven on dry road/rail surfaces. Thus, people usually need to mount and dismount tire chains onto/from their vehicles, depending on the weather and/or road conditions. As experienced by many, mounting and dismounting a tire chain is not an easy task, at least due to the weight of the tire chain and the complexity associated with the actual mounting and dismounting maneuver. In fact, many prior art tire chains are made of metal; hence they are heavy and feel cold in snowy or icy weather, difficult for people to handle.

A light-weight tire chain is disclosed in US patent application publication No. 2006/0090825 A1. This document relates to a device to be fitted on a vehicle wheel of a predetermined size in order to increase the friction between the wheel and a road surface in winter conditions. The device comprises a belt, made substantially of textile, intended to encircle the tread of a vehicle wheel. The belt is held and placed by means of flexible inner and outer side portions which, at least on the inner side of the wheel, it is tightened by means of an elastic member. Using textile instead of metal, this prior art device is light-weight and relatively easy to use.

Nevertheless, this prior art device fails to bring sufficient traction force between the wheel and the road surface. As can be imagined, such a deficiency can cause danger to the vehicle and its driver and/or passengers.

### SUMMARY

In view of the above, there is a need for a new tire chain, or a device of similar function, which is light-weight, easy for end-users to handle, and meet various standards and requirements including sufficient traction force.

To meet the above objective, the Inventors of the present invention conceive a device for increasing, enhancing, or improving, traction between a tire and a surface that the tire is in contact with.

The device exhibits many desirable features, such as:
It is easy to install; installation can be completed without moving the vehicle.
It is easy to repackage; the device as a product can fold in half and roll together easily.
It can sustain long periods of use on bare roads.
It has been independently tested and found to be better than cable chain on snow, ice and bare roads with regards to accelerating, braking, durability and traction.
Product fits over 410 tires sizes between 13 passenger and light truck part numbers.
Less than 1 lb difference between passenger and light truck model (13 part numbers).

In the present disclosure, “tire” shall be used to indicate any tire, any wheel, as well as any object that has a function similar to vehicle tires or wheels.

“Surface” means any kind of surface, including a road surface, a rail surface, a track surface, a trail surface, or similar. Snow- and ice-covered road/rail/trail/track surfaces are also considered as surfaces meant by the present disclosure.

“Traction”, in associated with an action of moving a tire over a surface, usually means the grip of the tire on that surface, and is usually the adhesive friction of the tire on the surface on which the tire is in contact with especially when moving thereon. Traction can also be termed as grip, friction, adhesion, and the like.

The device according to the present invention comprises two or more line structures. “Line” here means that the structure is substantially thin—thus light-weight—with respect to its length, such that it can be dealt with by normal people with ease.

At least two of the line structures are configured for encircling along the two sidewalls of the tire respectively. This is to say that the line structures embody such dimension and/or material property or properties that enable them to be (conveniently) mounted onto a tire such that at least two of the line structures form circles along the two sidewalls of the tire, respectively.

The device further comprises at least one cross member that connects or can connect the two or more line structures together. The cross member comprises certain connecting mechanism for connecting, bridging, joining, or linking, the two or more line structures together. The cross member is configured for contacting a tread portion of the tire; this means that, when the device is properly fitted onto the tire to perform its intended use in a normal way, the cross member is substantially in contact with the tread portion of the tire—without having to be pressed on the tread portion by any external force. “Tread portion” of the tire indicates the specific part of the outer surface(s) of the tire that is in contact with a surface on which the tire is on or moving along.

For at least a better effect of increasing tire traction, the device can be designed to comprise a plurality of such cross members.

Furthermore, at least one cross member of the device comprises a strap. A “strap” can also be termed as “strapping”, “webbing”, “band”, and “belt”, which are common terms used in the tire chain industry.

A strap has a substantially flat form and thus two sides; where the cross member contacts the tread portion of the tire when the device is fitted on the tire for its intended purpose, the side of the strap that touches the tread portion of the tire is defined to be the “tread side” of the strap. Analogously, the other side of the strap is termed as the “surface side” of the strap, since during normal use of the device when fitted on the tire this side of the strap gets in contact with the surface on which the tire is on or moving along.

One or more traction components may be attached to at least the surface side of the strap so as to further increase the traction between the tire and the surface.

Preferably, among said one or more traction components at least one of them is also attached to the tread side of the strap. That is, at least this particular one traction component is attached to both the tread side and the surface side of the strap.

Among the one or more traction components at least one further comprises a plurality of raised structures arranged on a surface side of the traction component.

Similar to the strap, a traction component has a substantially flat form and thus two sides. The side of a traction component that touches the strap is defined to be the “tread side” of the traction component. The other side of the traction component is termed as the “surface side” of the traction component, since during normal use of the device when fitted on the tire this side of the traction component gets in contact with the surface on which the tire is on or moving along.

With respect to a traction component having a plurality of raised structures attached thereto, at least one of the raised structures may be fitted with a stud, and, preferably at least (another) one of the plurality of raised structures may not fitted with any stud.

A “stud” is a small piece of structure that can be fitted on, or attached to, a surface of some object. In the context of the present invention, a stud is made of a relatively hard material and has a shape and size enabling it to penetrate and grip common types of substance that covers road surfaces; hence, the stud, when fitted on, or attached to, a raised structure, can create (more) traction between the tire and the road surface, Preferably, with respect to a traction component having a plurality of raised structures attached thereto, studded raised structures may be focused in a part of the traction component corresponding to a middle section of the cross member.

This is to say, there are more studded raised structures arranged in the part of the traction component which corresponds to the middle section of the cross member than in the end sections of the cross member (the end sections of the cross member being closer to the line structures). Less or no raised structures may be arranged on the part(s) of the traction component corresponding to the end sections of the cross member.

The stud may be made of metal, alloy, any other relatively hard material, or any combination of these materials.

Preferably, the stud may comprise one or more of carbon, nickel-manganese alloy, boron, tungsten carbide, and titanium.

The stud may assume of any of the following shapes: round, square, triangle, rectangular, multi-point (4-pointed star to 15-pointed star), multi-surfaced (5-flat surface sides to 11-flat surfaced sides). Among these possible shapes, preferable ones are round, square, triangle, 4-8 pointed star, and 5-8 flat surfaced sides. It should be added that studs of different shapes can exist on one traction component.

Possible sizes of the stud include: 1 mm-20 mm in diameter and/or 1 mm-20 mm in height. Among these possible sizes, preferable ones are 3 mm-10 mm in diameter and/or 2 mm-12 mm in height. It should be added that studs of different sizes can exist on one traction component.

The strap is made of a material which comprises, or mainly comprises, textile. Any textile will work. Through tests, the Inventors have found that at least the following types of textile achieve satisfactory results in terms of light-weight and sufficient traction force without requiring a high manufacturing cost: Nylon, polyester, polypropylene, leather, and cotton; the material of the strap can also be a combination of any one or more of these particular materials.

As mentioned above, the cross member(s) connect(s) the line structures together whereas the cross member(s) comprise(s) the strap(s). The dimension of the strap along the direction in which the cross member connects, or bridges, or joins, or links the line structures can be defined as the “length” of the strap, while the dimension in the other direction, substantially perpendicular to the length, can be defined as the “width” of the strap. Preferably, the width of the strap is between approximately ¾ of an inch and approximately 6 inch.

When a device comprises a plurality of cross members wherein each of which comprises a strap, each strap may be spaced from its neighboring straps by a distance.

The distance can be set to range between 0 and approximately 30 inch, in order to achieve satisfactory performance of the device.

The plurality of cross members can be arranged to form a certain pattern, or an arrangement of one or more sequences of repetitive form or forms. Through tests, the Inventors have determined that the following patterns, when adopted for the plurality of cross members, can bring out a satisfactory performance of the device while still keeping the manufacturing complexity and cost at a reasonable level.

The plurality of cross members can be arranged form a pattern comprising or characterized by a sequence of lines that are parallel, or substantially parallel to each other. That is, the cross members, while connecting the line structures of the device together, are arranged substantially parallel to one other among themselves when the device is fitted on a tire in order to perform its intended use in a normal way. Such a pattern resembles a “ladder” and can take any of the following forms: “I I”, “/ /”, and “\ \”, all of which are considered as variants of a “ladder” form.

In contrast to the “ladder” pattern(s), many other patterns formed by the plurality of cross members can comprise or characterized by a sequence of lines NOT parallel to each other.

For example, a pair of cross members adjacent to each other, when each connecting the line structures of the device together, can themselves cross each other at a certain location between the two line structures. In effect, the pair of cross members forms an “X”, whereas the cross point may or may not be exactly in the middle. Several pairs of cross members can form a sequence of “X” forms.

Alternatively, a pair of cross members adjacent to each other, when each connecting the line structures of the device together, can meet, or join, each other at a common end. The common end is an end of both cross members. The common end may be in contact with a particular line structure or the connecting mechanism connecting that line structure.

In effect, the pair of cross members forms a form similar to “V”, “I/”, “/I”, “I\”, or “\I”, all of which are considered as variants of a “V form”. Several pairs of cross members can form a sequence of “V”, “I/”, “/I”, “I\”, or “\I” forms.

Through tests, the Inventors have found that a pattern comprising a sequence of “V” forms gives the device a particularly satisfactory performance in terms of light-weight and sufficient tire traction, whereas the manufacturing complexity and the cost of the device can still be controlled at a reasonable level.

Between a pair of cross members that forms the “V” form, an angle exists at the common end thereof. For satisfactory result of tire traction, the inter-relationship of the cross members of the device can be adjusted so that this angle is set between approximately 45 degrees and approximately 90 degrees; for better result of tire traction, the angle is set between approximately 50 degrees and approximately 60 degrees or between approximately 60 degrees and approximately 75 degrees; and for even better result of tire traction the angle is between approximately 45 degrees and approximately 50 degrees.

Another alternative may have a pair of cross members adjacent to each other, when each connecting the line structures of the device together, be arranged to resemble two unparallel sides of a trapezoidal (wherein the two line structures resemble the two parallel sides of the trapezoidal). In other words, the two cross members are not parallel to each other, and neither do they cross or meet each other. In effect, the pair of cross members forms a form resembling a “I /”, “/ I”, “I \”, “\ I”, “\ /” or “/ \”, all of which are considered as variants of a “trapezoidal form”. Several pairs of cross members can form a sequence of “I \”, “/ I”, “I \”, “\ I”, “\ /” or “/ \” forms.

Further alternatives may arrange a plurality of cross members of the device to exhibit a pattern comprising a combination of more than one kind of the above mentioned (basic) forms: “I I”, “/ /”, “\ \”, “X”, “V form”, and “trapezoidal form”. In other words, a mixture of sequences of different basic forms presented above is possible for the device.

Still further alternative(s) can be provided by adding, between a pair of cross members that are adjacent to each other, a connecting member that connects the two crossing members, so that the entire plurality of cross members form a pattern comprising a sequence of such pair of cross member plus the connecting member.

Examples of the forms forming the sequence include and are not limited to the following: “H”, “/-/”, \-\” “N”, “ [symbol] ”, “A”, “I-/”, “/-I”, “I-\” “\-I”, “\-\” or “/-\”.

Moreover, more than one connecting members may be added between a pair of cross members that are adjacent to each other, to thus form, for example, a “#”, “M” “W”, forms; thus several pairs of cross members can form a sequence of such forms.

Even forms resembling “Y”, “K”, diamond, different shapes of star, different shapes of web form(s), different shapes of net form(s), can be applied to the present invention to form a pattern for the plurality of cross members of the device.

All the patterns mentioned above achieve a satisfactory result of traction force for the device. Certain patterns outperform the other patterns, depending on various factors such as road conditions, tire features, vehicle features, etc.

Preferably, the one or more traction components mentioned above may further comprise one or more raised structures on a surface side thereof.

Like the strap, the traction component has a substantially flat form too and thus two sides. Where the cross member contacts the tread portion of the tire when the device is fitted on the tire for its intended purpose, the side of the strap that touches the tread portion of the tire is defined to be the “tread side” of the strap, and the other side of the strap, the “surface side”, since that is the side that would be in contact with the surface on which the tire is on or moving along. Similarly, when the device is mounted on a tire to perform its intended use in a normal way, the side of a traction component that gets in contact with the surface on which the tire is on or moving along is the “surface side” of the traction component, while the other side, the “tread side” of the traction component.

As its name indicates, the “raised structures”, while comprised in the traction components, are formed and arranged to project away from the surface side of the traction component(s) when the device is fitted onto the tire to perform its intended use in a normal way. In effect, the raised structures “raise” up to a certain height above the surface of the traction component(s). With such one or more raised structures, the device, when in use, can achieve stronger traction between the tire and the surface the tire is in contact with.

The one or more raised structures are preferably made of a material that comprises one or more of the following: thermoplastic polyurethane, metal, alloy, plastic, sand, polymer (such as polystyrene), and any type of textile.

Each of the one or more raised structures has a length of from 3 inches to 20 inches and a width of from 0.3 inches to 6 inches.

At least one of the line structures mentioned above can be a cable (such as a rim cable used in many tire chains), a chain, or a rope.

At least one of the line structures may be made of metal, alloy, plastic, thermoplastic polyurethane, rubber, any kind of textile, or any combination of these materials. In other words, the line structure is made of a material that may comprise any one of more of metal, alloy, plastic, thermoplastic polyurethane, rubber, and textile.

One or more cross members of the device mentioned above can be secured, or attached to the line structures via various connecting means. For example, at least one of the cross members can be attached to at least one line structure through an eyelet structure. For another example, at least one cross member can be sewn onto at least one line structure, or the cross member can be folded over the line structure and then sewn there-onto.

The present disclosure further provides a strap that is suitable for use in the device mentioned above. The strap may be used as a replacement to an existing strap (for example, a worn-out or a defect strap) on the device or can be added onto the device in order to further increase the traction between the tire and the surface the tire is in contact with when the device is fitted on the tire to perform its intended use.

The strap comprises connecting mechanism to allow the strap to be fitted onto the device by connecting the two or more line structures of the device together. Examples of the connecting mechanism include eyelet(s), button(s), buckle(s), gluing, and sewing, to name a few. More than one particular mechanism can be combined to achieve a more secure connection of the strap to the line structures of the device.

The strap further comprises one or more traction components discussed above, the traction component(s) attached to at least one side of the strap; this side shall be the “surface side” of the strap when the strap is fitted onto the device. Preferably, the at least one traction components is also attached to another side of the strap.

As discussed above, among the one or more traction components at least one further comprises a plurality of raised structures arranged on a surface side of the traction component.

With respect to a traction component having a plurality of raised structures attached thereto, at least one of the raised structures may be fitted with a stud as discussed above, and, preferably at least (another) one of the plurality of raised structures may not fitted with any stud.

Preferably, with respect to a traction component having a plurality of raised structures attached thereto, studded raised structures may be focused in the middle section of the traction component. This is to say, there are more studded raised structures arranged in the middle section of the traction component than in the end sections (the end sections being closer to the line structures). Less or no raised structures may be arranged on the end sections of the traction component.

Preferably, with respect to a traction component having a plurality of raised structures attached thereto, studded raised structures may be focused in a part of the traction component corresponding to a middle section of the strap. This is to say, there are more studded raised structures arranged in the part of the traction component which corresponds to the middle section of the strap than in the end sections of the strap. Less or no raised structures may be arranged on the part(s) of the traction component corresponding to the end sections of the strap.

The stud may be made of metal, alloy, any other relatively hard material, or any combination of these materials.

Preferably, the stud may comprise one or more of carbon, nickel-manganese alloy, boron, tungsten carbide, and titanium.

The stud may assume of any of the following shapes: round, square, triangle, rectangular, multi-point (4-pointed star to 15-pointed star), multi-surfaced (5-flat surface sides to 11-flat surfaced sides). Among these possible shapes, preferable ones are round, square, triangle, 4-8 pointed star, and 5-8 flat surfaced sides. It should be added that studs of different shapes can exist on one traction component.

Possible sizes of the stud include: 1 mm-20 mm in diameter and/or 1 mm-20 mm in height. Among these possible sizes, preferable ones are 3 mm-10 mm in diameter and/or 2 mm-12 mm in height. It should be added that studs of different sizes can exist on one traction component.

Preferably, the strap may be made of a material comprising textile such as nylon, polyester, polypropylene, leather, cotton and so on. In other words, the strap material may comprise one or more of nylon, polyester, polypropylene, leather, cotton and any other textile.

One dimension of the strap is between approximately ¾ inch and approximately 6 inch.

### BRIEF DESCRIPTION OF THE DRAWINGS

The present disclosure will be better understood when consideration is given to the following detailed description of the exemplifying embodiments schematically shown in the annexed drawings, wherein:

FIG. 1 shows the first embodiment of the device not fitted on a tire;

FIG. 1A shows a first embodiment of the device according to the present invention whereas the device is shown to be fitted on a tire;

FIG. 2 shows the second embodiment of the device not fitted on a tire;

FIG. 2A shows a second embodiment of the device according to the present invention whereas the device is shown to be fitted on a tire;

FIG. 3 shows a first embodiment of the strap according to the present invention;

FIG. 4 shows a second embodiment of the strap according to the present invention;

FIG. 5 shows a third embodiment of the strap according to the present invention;

FIG. 6 shows a further embodiment of the device according to the present invention;

FIG. 6A shows a further embodiment of the device according to the invention;

FIG. 7 shows yet a further embodiment of the device according to the present invention;

FIG. 8 shows an embodiment of a traction component used in the strap according to the present invention; and

FIG. 8A shows another embodiment of a traction component used in the strap according to the present invention.

### DETAILED DESCRIPTION OF EMBODIMENTS

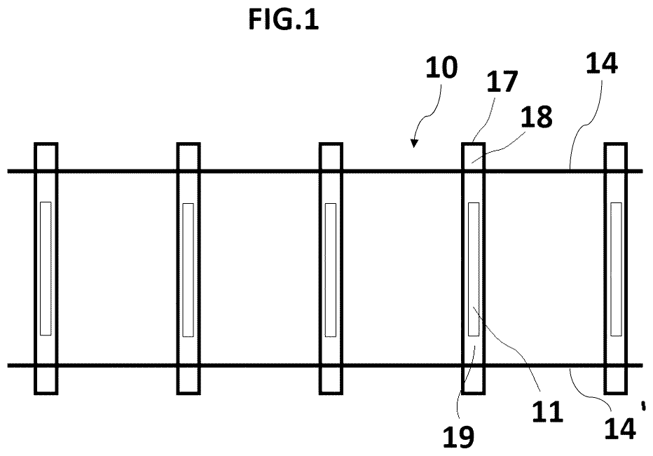

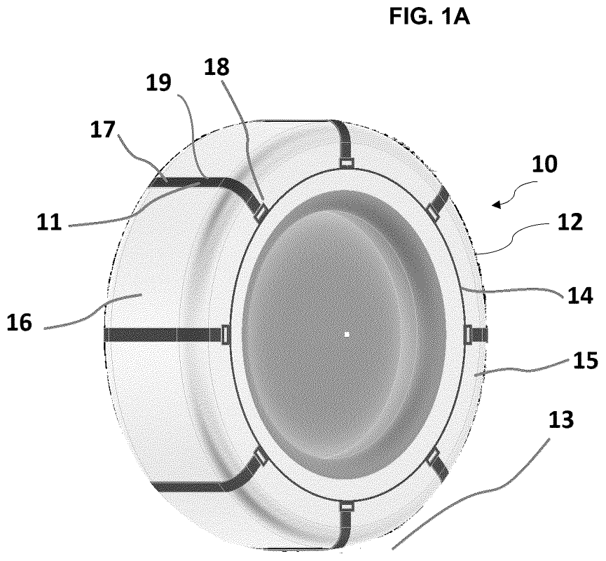

FIG. 1 and FIG. 1A illustrate a first embodiment of the device for increasing traction between a tire and a surface the tire is in contact with.

Specifically, in FIG. 1, only the device 10 is shown, while in FIG. 1A, the device 10 is shown to be fitted onto a tire 12, which is on a surface 13. The surface 13 may be a road surface, which may be covered with or without substance such as water, snow, ice, etc.

The device 10 comprises two or more line structures 14 and 14′, although only one of them, 14, is shown in FIG. 1A. As shown in FIG. 1A, the tire 12 comprises two sidewalls substantially opposite to each other; line structure 14 encircles one sidewall 15, whereas the other line structure 14′ encircles the other sidewall (not shown in FIG. 1′) in a similar fashion. The outer surface of the tire 12 comprises a tread surface, or a tread portion, denoted as 16 in FIG. 1. During driving or moving of a vehicle, the tread surface 16 of the tire 12 is the portion that touches the road surface 13.

The line structures 14 and 14′ are configured for encircling along the two sidewalls of the tire 12, respectively. To be suitable for such purpose, the line structures 14 and 14′ embody such dimension and material property/properties that enable them to be (conveniently) mounted onto the tire and to form a circle along the sidewalls of the tire 12. For example, the line structures 14 and 14′ are of suitable length so that, when the device 10 is properly mounted on the tire 12 in order to perform its function in a normal way, the lines structures 14 and 14′ abut the sidewalls wherein the contact is neither too tight nor too loose. From another perspective, the line structures 14 and 14′ are made of a certain material exhibiting suitable strength, light-weight, and/or flexibility so that it is relatively easy for end-users to mount the device 10 onto the tire 12 as well as to dismount it.

As further shown in FIG. 1 and FIG. 1A, the device 10 comprises a plurality of cross members 17. Although a plurality of cross members 17 are shown, it is possible that the device according to the present invention uses only one cross member 17.

Nevertheless, having a plurality of cross members 17 can achieve a better effect of increasing tire traction.

The at least one cross member 17 is configured for contacting the tread portion 16 of the tire 12. This is to say, when the device 10 is properly fitted/mounted on the tire 12 in order to perform its intended use in a normal way, the cross member 17 is substantially in contact with the tread portion 16 of the tire 12—without having to be pressed on the tread portion 16 by any external force.

Further, as can be seen in FIG. 1 and FIG. 1A, the cross member 17 is connected to the two line structures 14 and 14′. Specifically, the cross member 17 may comprise certain connecting mechanism 18 for connecting, bridging, joining, or linking, the line structures 14 and 14′ together. In principle, the connecting mechanism 18 should be properly designed so that, when the device 10 is fitted/mounted on the tire 12 to perform its intended use in a normal way, the cross member 17 is securely connected to the line structures 14 and 14′ and is substantially in contact with the tread portion 16 of the tire 12—without having to be pressed on the tread portion 16 by any external force. Connecting mechanism 18 shall be described in more details below.

As can be seen from FIG. 1 and FIG. 1A, at least one of the cross members 17 comprises a strap 19. “Strap” can also be termed as strapping, webbing, band, belt, and so on. Strap 19 is made of a material that comprises textile. One or more traction components 11 are attached to at least the surface side of the strap 19, to further increase the traction between the tire 12 and the surface 13. FIG. 1 and FIG. 1A show the traction component 11 in the form of a rectangle, but other regular or irregular forms can be used too, such forms including but are not limited to circle, oval, triangle, square, diamond, trapezoidal, star, any polygon, wave, or any irregular form. Further, more than one traction component in the same or different forms can be attached to each strap 19 of the device 10.

As shown in FIG. 1 and FIG. 1A, the traction components 11 are attached to the straps 19 on the surface side thereof. However, it is possible to have at least one traction component 11 also attached to another side of at least one particular strap 19.

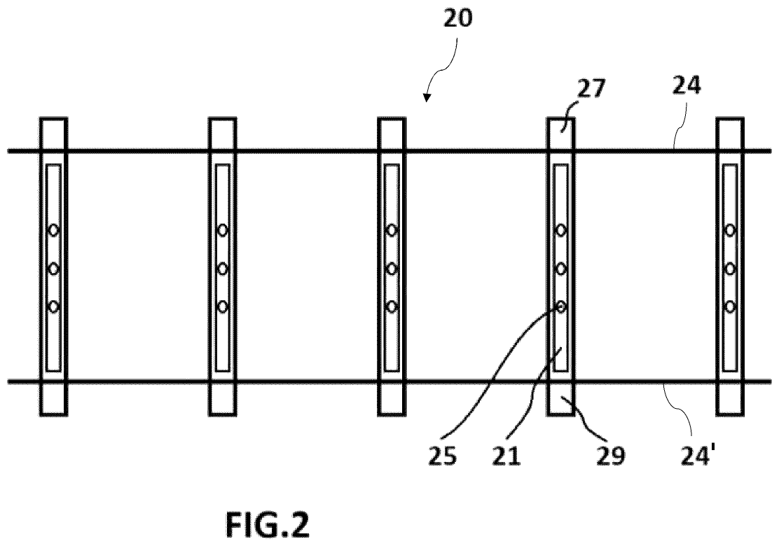

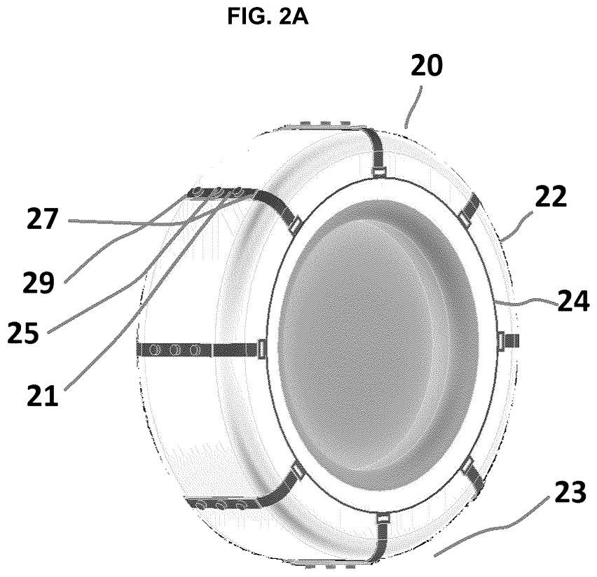

FIG. 2 and FIG. 2A illustrate a second embodiment of the device for increasing traction between a tire and a surface the tire is in contact with. Specifically, in FIG. 2 only the device 20 is shown, while in FIG. 2A the device 20 is shown to be fitted onto a tire 22, which is on a surface 23.

The embodiment of FIGS. 1/1A and that of FIGS. 2/2A are similar except for that the latter further comprises a plurality of raised structures 25 provided on, or attached to, each traction component 21. Not shown in FIGS. 2/2A is a similar embodiment where only one or more but not all of the traction components 21 are provided with a plurality of raised structures 25. In fact, instead of a plurality of raised structures 25, a single raised structure 25 also works. With one or more raised structures 25, the device 20, when in use, can achieve stronger traction between the tire 22 and the surface 23 the tire 22 is in contact with.

The one or more raised structures 25, while comprised in the traction components 21, are formed and arranged to project away from the surface side of the strap 29 when the device 20 is fitted onto the tire 22 to perform its intended use in a normal way. As shown clearly in FIG. 2A, the raised structures 25 “raise” up to a certain height above the surface of the surface side of the strap 29. The raised structures 25 are preferably made of a material that comprises one or more of the following: thermoplastic polyurethane, metal, alloy, plastic, sand, polymer (such as polystyrene), and any type of textile.

Each of the one or more raised structures has a length of from 3 inches to 20 inches and a width of from 0.3 inches to 6 inches.

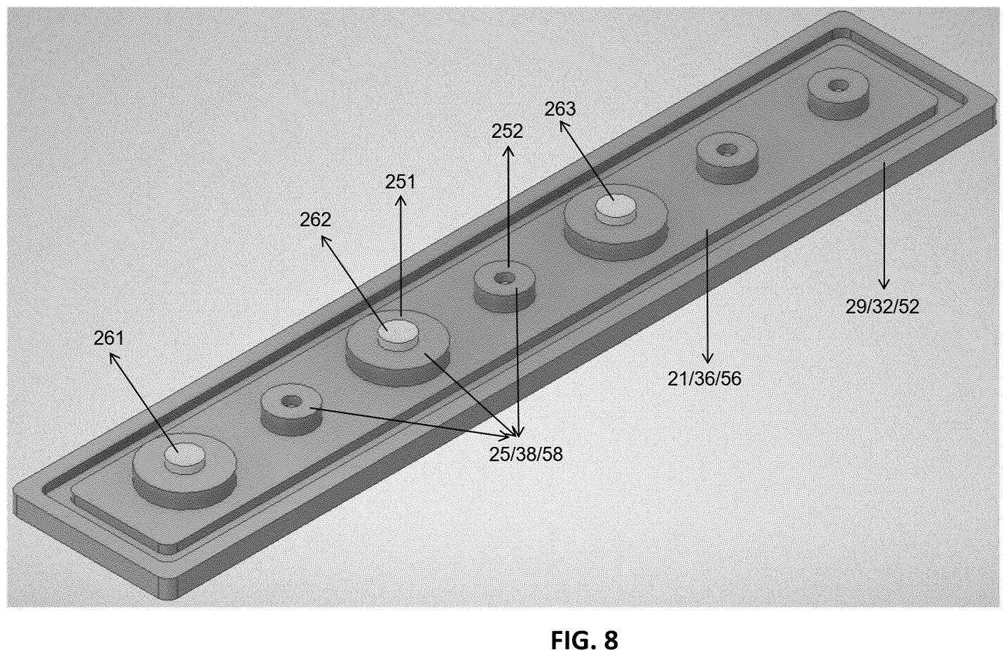

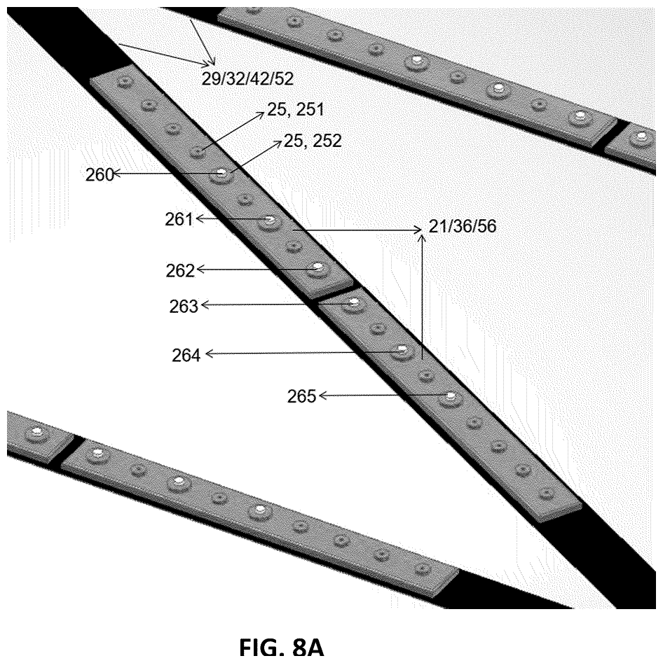

Referring to FIG. 8, with respect to a traction component 21/36/56 having a plurality of raised structures 25/38/58, 251, 252 attached thereto, at least one 251 of the plurality of raised structures is fitted with a stud 262 and at least (another) one 252 of the plurality of raised structures is not fitted with any stud.

Further, as shown in FIG. 8A, wherein with respect to a traction component 21/36/56 having the plurality of raised structures 25/38/58, 251, 252 attached thereto, studded raised structures (261, 262, 263, 264) are focused in a part of the traction component 21/36/56 corresponding to a middle section of the cross member 27 (not shown in this figure).

A stud (261, 262, 263, 264) may be made of metal, alloy, any other relatively hard material, or any combination of these materials. Preferably, a stud (261, 262, 263, 264) may comprise one or more of carbon, nickel-manganese alloy, boron, tungsten carbide, and titanium.

With respect to all the embodiments shown in FIG. 1/1A and FIG. 2/2A and FIG. 8/8A, the strap 19 and 29 is made of a material which comprises, or mainly comprises, textile; any textile can be used. Through tests, the Inventors have found that at least the following types of textile achieve satisfactory results in terms of light-weight and sufficient traction force without requiring a high manufacturing cost: Nylon, polyester, polypropylene, leather, and cotton. The material of the strap can also be a combination of any one or more of these particular materials.

With respect to all the embodiments shown in FIG. 1/1A and FIG. 2/2A and FIG. 8/8A, each cross member 17, 27 connects the line structures 14 with 14′, and 24 with 24′ together whereas the cross member 17, 27 comprises the strap 19, 29. The dimension in the direction along which the strap 19, 29 connects, or bridges, or joins or links the line structures 14 with 14′ and 24 with 24′ can be defined as the “length” of the strap 19, 29, while the other dimension, substantially perpendicular to the length, can be defined as the “width” of the strap 19, 29. Preferably, the width of the strap 19, 29 is between approximately ¾ of an inch and approximately 6 inch.

Where the device 10 or 20 comprises a plurality of cross members 17, 27, and each of which 17, 27 comprises a strap 19, 29, each strap 19, 29 may be spaced from its neighboring straps by a distance. The distance can be set to range between 0 and approximately 30 inch, in order to achieve satisfactory performance of the device 10, 20. In all the embodiments of the device shown in FIG. 1/1A and FIG. 2/2A and FIG. 8/8A, the distance is larger than 0.

With respect to all the embodiments shown in FIG. 1/1A and FIG. 2/2A and FIG. 8/8A, at least one of the line structures 14/14′, 24/24′ can be a cable (such as a rim cable used in many tire chains), a chain, or a rope. At least one of the line structures 14/14′, 24/24′ is made of metal, alloy, plastic, thermoplastic polyurethane, or any kind of textile. Any combination of one or more of such materials can also be used for making the line structure.

The present disclosure further provides a strap that is suitable for use in the device for increasing traction between a tire and a surface the tire is in contact with. The strap may be used as a replacement to an existing strap (for example, a worn-out or a defect strap) on the device or can be added onto the device in order to further increase the traction between the tire and the surface the tire is in contact with when the device is fitted on the tire to perform its intended use.

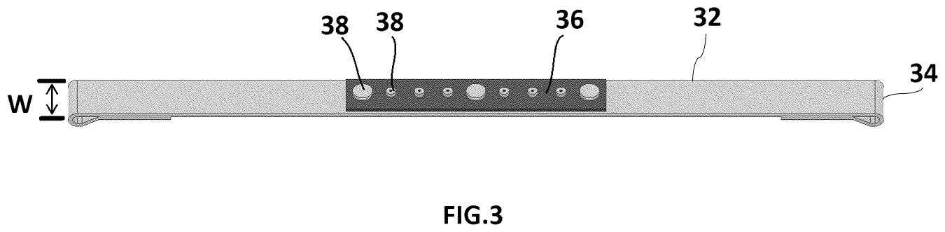

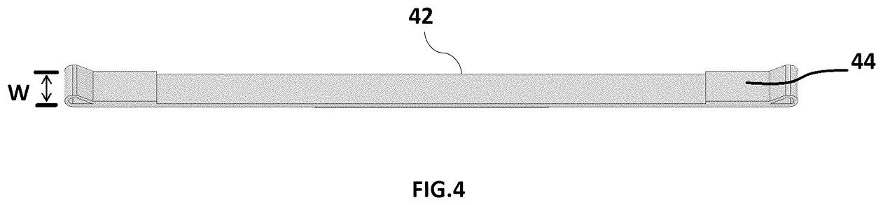

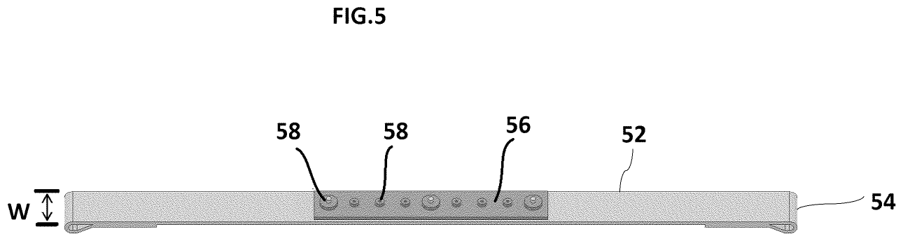

Embodiments of such a strap is illustrate in FIG. 3, FIG. 4, and FIG. 5. The strap, denoted as 32, 42, and 52 in these figures, is made of a material comprising textile. The strap 32, 42, and 52 comprises a certain connecting mechanism 34, 44, and 54 to allow the strap 32, 42, and 52 to be fitted onto the device by connecting the two or more line structures of the device together. The strap 32, 42, and 52 has a substantially flat form and thus two sides; FIG. 3 and FIG. 4 respectively show the two sides of a strap 32, 42.

The strap 32 and 42 comprises two folded ends whereas the folding of each end forms a through hole for a line structure to pass through. Other examples of the connecting mechanism include eyelet(s), button(s), buckle(s), gluing, and sewing, to name a few.

More than one particular mechanism can be combined to achieve a more secure connection of the strap 32, 42, 52 to the line structures of the device.

With reference to FIG. 3 and FIG. 5, the strap 32, 52 may further comprises one or more traction components 36, 56 attached to one side of the strap 32, 52. In some embodiments (not shown in the drawings), the at least one traction component 36, 56 may also be attached to another side of the strap 32, 52.

Assuming that the strap 32, 52 is fitted onto a device provided by the present invention and the device is fitted onto a tire to perform its intended use, one can call this particular side of the strap 32, 52 the “surface side” since this side will be in contact with the surface on which a tire is on or moving along. The other side of the strap could be named as the “tread side” of the strap.

Preferably, the material of the strap 32, 42, 52 may comprise one or more of nylon, polyester, polypropylene, leather, and cotton.

The strap 32, 42, 52 has a width, indicated as “W” in the FIGS. 3-5. Preferably, width W is between approximately ¾ inch and approximately 6 inch.

As shown in FIG. 3 and FIG. 5, the strap 32 and 52 further comprises a plurality of raised structures 38, 58 provided on the traction component 36, 56, respectively. The raised structures 38, 58 are formed and arranged to project away from the traction component 36, 56 such that they “raise” up to a certain height above the surface side of the strap 32, 52.

Preferably, the raised structures 38, 58 are made of a material that comprises one or more of the following: thermoplastic polyurethane, metal, alloy, plastic, sand, polymer (such as polystyrene), and any type of textile.

Referring to FIG. 8, with respect to a traction component 21/36/56 having a plurality of raised structures 25/38/58, 251, 252 attached thereto, at least one 251 of the plurality of raised structures 25/38/58 is fitted with a stud 262 and at least another one 252 of the plurality of raised structures 25/38/58 is not fitted with any stud.

Further, as shown in FIG. 8A, wherein with respect to a traction component 21/36/56 having the plurality of raised structures 25/38/58, 251, 252 attached thereto, studded raised structures (261, 262, 263, 264) are focused in a part of the traction component 21/36/56 corresponding to a middle section of the strap 29/32/42/52.

A stud (261, 262, 263, 264) may be made of metal, alloy, any other relatively hard material, or any combination of these materials. Preferably, a stud (261, 262, 263, 264) may comprise one or more of carbon, nickel-manganese alloy, boron, tungsten carbide, and titanium.

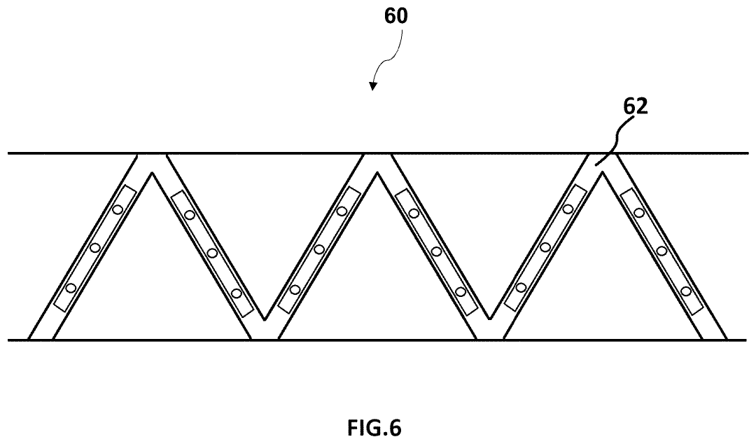

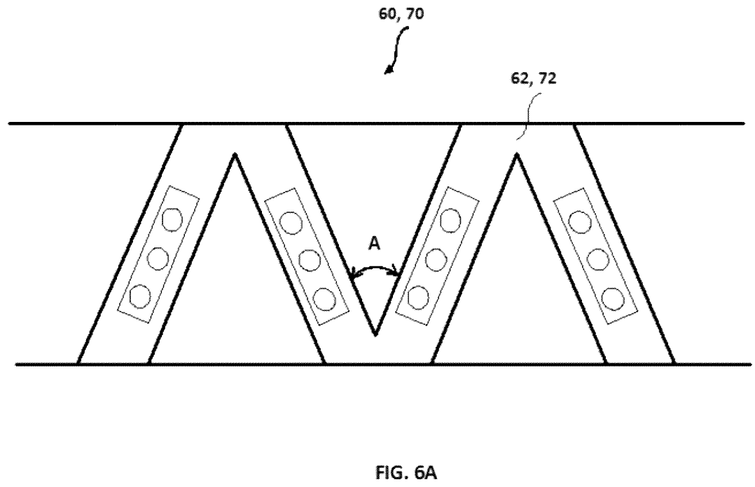

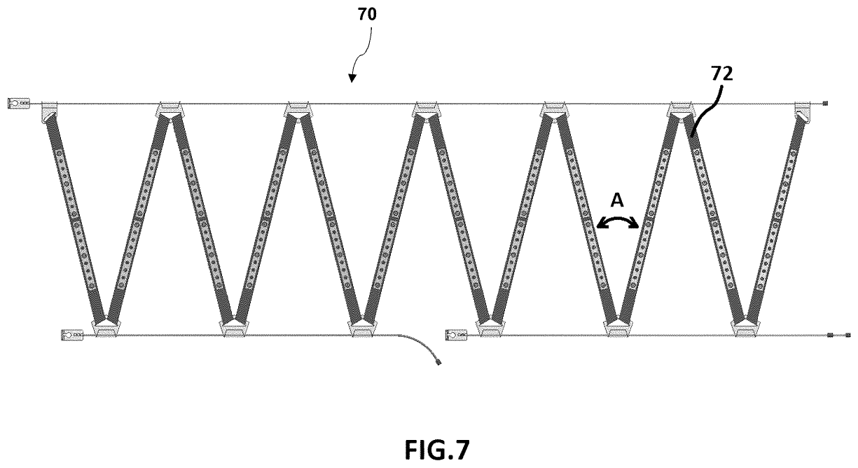

Referring to FIG. 6, FIG. 6A and FIG. 7, which show yet three further embodiments of the device 60, 70 according to the present invention for increasing traction between a tire and a surface the tire is in contact with. Both devices 60 and 70 comprise a plurality of cross members 62, 72 which are arranged to form a certain pattern, a pattern comprising a sequence of “V” forms, to be specific. As already discussed above, many other patterns can be formed by the plurality of cross members of the device of the present invention.

Different patterns formed by the plurality of cross members can impact the performance as well as user convenience of the device. For example, more complex patterns may lead to a better result of tire traction; whereas simpler patterns may contribute to the light-weight of the device. Other factors of the device may also be influenced by the patterns of the plurality of cross members.

Through tests, the Inventors have found that the pattern comprising a sequence of “V” forms, such as figuratively shown in FIG. 6, FIG. 6A, and FIG. 7, can contribute to a highly satisfactory device (in terms of, inter alia, light-weight and sufficient traction force) while still keeping the manufacturing complexity and cost at a reasonable level.

Through tests, the Inventors have found that a pattern comprising a sequence of “V” forms gives the device a particularly satisfactory performance in terms of light-weight and sufficient tire traction, whereas the manufacturing complexity and the cost of the device can still be controlled at a reasonable level.

Between a pair of cross members that forms the “V” form, an angle A, which is shown in FIGS. 6, 6A, and 7, exists at the common end thereof. For satisfactory result of tire traction, the inter-relationship of the cross members 62, 72 of the device 60, 70 can be adjusted so that angle A is set between approximately 45 degrees and approximately 90 degrees; for better result of tire traction, the angle A may be set between approximately 50 degrees and approximately 60 degrees or between approximately 60 degrees and approximately 75 degrees; and for even better result of tire traction the angle A may be set between approximately 45 degrees and approximately 50 degrees, as shown in FIG. 6A.

It will also be understood that the present invention is not limited to the exemplifying embodiments described above, but that it may be modified and varied by the skilled person within the scope of the appended claims.

What is claimed is:

1. A device for increasing traction between a tire and a surface the tire is in contact with, comprising
two or more line structures, at least two of which configured for encircling along two side walls of the tire, respectively;
a plurality of cross members configured for contacting a tread portion of the tire, the cross members comprising mechanism for connecting the two or more line structures together;
wherein at least one of the cross members comprises a strap, one or more traction components attached to at least a surface side of said strap;
wherein said one or more traction components further comprise a plurality of raised structures arranged on a surface side of the traction components;
wherein with respect to a traction component having a plurality of raised structures attached thereto, at least one of the plurality of raised structures is fitted with a stud and at least another one of the plurality of raised structures is not fitted with any stud.

2. The device according to claim 1, wherein with respect to a traction component having the plurality of raised structures attached thereto, studded raised structures are focused in a part of the traction component corresponding to a middle section of the cross member.

3. The device according to claim 1, wherein said stud is made of a material comprising one or more of carbon, nickel-manganese alloy, boron, tungsten carbide, and titanium.

4. The device according to claim 1, wherein said plurality of raised structures are made of a material comprising one or more of rubber, thermoplastic polyurethane, metal, alloy, plastic, sand, polystyrene, and textile.

5. The device according to claim 1, wherein each of said plurality of raised structures has a length of from 3 inches to 20 inches and a width of from 0.3 inches to 6 inches.

6. The device according to claim 1, wherein the strap is made of a material comprising textile.

7. The device according to claim 6, wherein the strap material comprises one or more of nylon, polyester, polypropylene, leather, and cotton.

8. The device according to claim 1, wherein said strap has a width of between approximately ¾ inch and approximately 6 inch.

9. The device according to claim 1, wherein each strap is spaced from a neighboring strap by a distance ranging between 0 and approximately 30 inch.

10. The device according to claim 1, wherein said plurality of cross members form a pattern comprising a sequence of lines substantially parallel to each other.

11. The device according to claim 1, wherein said plurality of cross members form a pattern comprising a sequence of lines unparallel to each other.

12. The device according to claim 11, wherein at least two lines in the sequence that are adjacent to each other meet at a common end to form a “V” form.

13. The device according to claim 12, wherein an angle (A) between the two lines forming the “V” form is in a range of between approximately 45 degrees and approximately 90 degrees.

14. The device according to claim 12, wherein the angle (A) is between approximately 50 degrees to approximately 60 degrees or between approximately 60 degrees and approximately 75 degrees.

15. The device according to claim 12, wherein the angle (A) is between approximately 45 degrees and approximately 50 degrees.

16. The device according to claim 1, wherein said plurality of raised structures are configured to project away from said surface side of the traction components when said device is fitted onto the tire.

17. The device according to claim 1, wherein at least one of said two or more line structures is a cable, a chain, or a rope.

18. The device according to claim 1, wherein at least one of said two or more line structures is made of a material that comprises any one or more of metal, alloy, plastic, thermoplastic polyurethane, rubber, and textile.

19. The device according to claim 1, wherein among said one or more cross members, at least one pair of cross members which are immediately adjacent to each other are arranged to resemble two unparallel sides of a trapezoidal when said at least one pair of cross members connect the line structures of the device together.

20. The device according to claim 1, wherein among said one or more cross members, each pair of cross members which are immediately adjacent to each other join each other at a common end which is an end of both cross members, the common end being in contact with one of said at least two line structures or the connecting mechanism connecting that line structure.

21. A strap suitable for use in the device according to claim 1, said strap for increasing traction between a tire and a surface the tire is in contact with, wherein the strap can be fitted onto the device to connect the two or more line structures of the device together,
wherein the strap comprises one or more traction components attached to at least one side of said strap;
wherein said one or more traction components further comprise a plurality of raised structures arranged on a surface side of the traction components; and
wherein with respect to a traction component having a plurality of raised structures attached thereto, at least one of the plurality of raised structures is fitted with a stud and at least another one of the plurality of raised structures is not fitted with any stud.

22. The strap according to claim 21, wherein with respect to a traction component having the plurality of raised structures attached thereto, studded raised structures are focused in a part of the traction component corresponding to a middle section of the strap.

23. The strap according to claim 21, wherein said stud is made of a material comprising one or more of carbon, nickel-manganese alloy, boron, tungsten carbide, and titanium.

24. The strap according to claim 21, wherein said plurality of raised structures are made of a material comprising one or more of rubber, metal, alloy, plastic, thermoplastic polyurethane, sand, polystyrene, and textile.

25. The strap according to claim 21, wherein strap is made of a material comprising textile.

26. The strap according to claim 25, wherein the strap material comprises one or more of nylon, polyester, polypropylene, leather, and cotton.

27. The strap according to claim 21, wherein each of said plurality of raised structures has a length of from 3 inches to 20 inches and a width of from 0.3 inches to 6 inches.

28. The strap according to claim 21, wherein said strap has a width of between approximately ¾ inch and approximately 6 inch.
